(19) United States
(12) Patent Application Publication
(10) Pub. No.: US 2014/0117808 A1
(43) Pub. Date: May 1, 2014

(54) ELECTRIC MOTOR

(71) Applicant: HYUNDAI MOTOR COMPANY, Seoul (KR)

(72) Inventors: Soo Hyung Woo, Yongin-si (KR); Jin Kook Kong, Suwon-si (KR); Jin Soon Kim, Hwaseong-si (KR)

(73) Assignee: Hyundai Motor Company, Seoul (KR)

(21) Appl. No.: 13/720,038

(22) Filed: Dec. 19, 2012

(30) Foreign Application Priority Data
Oct. 29, 2012 (KR) 10-2012-0120750

(51) Int. Cl. H02K 13/10; H02K 13/00

(52) U.S. Cl. CPC H02K 13/10; H02K 13/006
USPC 310/233

(57) ABSTRACT

An electric motor includes: an electric motor case shaped like a cylinder; an electric motor shaft rotatably provided at a center of the electric motor case; a magnet provided at an inner circumferential surface of the electric motor case; a coil provided to correspond to the magnet; a brush provided between the coil and the electric motor shaft and connected with an external power to transmit current of the external power; and a commutator configured to receive power from the brush and supply the received power to the coil.

### CROSS-REFERENCE TO RELATED APPLICATION

The present application claims priority of Korean Patent Application Number 10-2012-0120750 filed Oct. 29, 2012, the entire contents of which application is incorporated herein for all purposes by this reference.

### BACKGROUND OF INVENTION

1. Field of Invention

The present invention relates to an electric motor, and more particularly, to an electric motor of which a longitudinal direction can be decreased.

2. Description of Related Art

General electric motors require a space in order to allow contact between a brush and an electrode of a commutator.

However, the commutator is generally coupled to a motor shaft, and the brush is provided outside the commutator. Accordingly, when a limitation of an installation space, that is, a length, of an electric motor used in a continuous variable valve timing apparatus is generated, there is a problem in that output (torque) is decreased according to limitation in the longitudinal direction of the motor.

That is, in order to decrease the length of the electric motor, an entire size needs to be inevitably decreased, so that there is a problem in that output of the electric motor is decreased. For example, when a length of a core is decreased due to the spatial limitation, deterioration of strength of electromagnet (magnetic field) is eventually caused, such that rotation torque of the electric motor deteriorates.

Further, when a size of the motor is increased in order to prevent output power deterioration, there is a problem in that an entire size and weight of an apparatus including the motor are increased.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for an electric motor having advantages of having a decreased length of a motor without the loss of output power.

Various aspects of the present invention provide for an electric motor, including: an electric motor case shaped like a cylinder; an electric motor shaft rotatably provided at a center of the electric motor case; a magnet provided at an inner circumferential surface of the electric motor case; a coil provided to correspond to the magnet; a brush provided between the coil and the electric motor shaft and connected with an external power to transmit current of the external power; and commutator configured to receive power from the brush and supply the received power to the coil.

A horizontal arm may extend from the electric motor shaft in a diameter direction of the electric motor shaft, a vertical arm may be formed at the horizontal arm in parallel to a longitudinal direction of the electric motor shaft; and a core may be coupled to the vertical arm, and the core is wound with the coil.

The commutator may be coupled with the vertical arm and may be provided between the brush and the vertical arm.

A bearing may be provided between the electric motor case and the electric motor shaft.

The electric motor may further include a brush cover surrounding the brush.

The electric motor may further include an insulator provided between the brush cover and the electric motor case.

A shaft arm hole may be formed at the horizontal arm, and the commutator and the coil may be electrically connected through the shaft arm hole.

The electric motor may be a DC electric motor.

The electric motor may be an AC electric motor.

Various aspects of the present invention provide for an electric motor including: an electric motor case shaped like a cylinder; a hollow electric motor shaft rotatably provided at a center of the electric motor case; a magnet provided at an inner circumferential surface of the electric motor case; a coil provided to correspond to the magnet; a brush provided between the coil and the electric motor shaft and connected with an external power to transmit current of the external power; and a commutator configured to receive power from the brush and supply the received power to the coil.

A horizontal arm may extend from the electric motor shaft in a diameter direction of the electric motor shaft, a vertical arm may be formed at the horizontal arm in parallel to a longitudinal direction of the electric motor shaft, a core may be coupled to the vertical arm, and the core may be wound with the coil.

The commutator may be coupled with the vertical arm and may be provided between the brush and the vertical arm.

A sealing member may be provided between the electric motor case and the electric motor shaft.

The electric motor may further include a brush cover surrounding the brush.

The electric motor may further include an insulator provided between the brush cover and the electric motor case.

A shaft arm hole may be formed at the horizontal arm, and the commutator and the coil may be electrically connected through the shaft arm hole.

Bearings may be provided between the electric motor case and the vertical arm and between the electric motor case and the horizontal arm, respectively.

The electric motor may be a DC electric motor.

The electric motor may be an AC electric motor.

According to various aspects of the present invention, a length of the motor may be decreased without the loss of output power.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a cross-sectional view of an exemplary electric motor according to the present invention.

FIG. 2 is a cross-sectional view of an exemplary electric motor according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Further, throughout this specification, parts indicated by the same reference number mean the same constituent elements.

In the drawings, the thickness of layers, films, panels, regions, etc., are exaggerated for clarity.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

Throughout the specification, unless explicitly described to the contrary, the word “comprise” and variations such as “comprises” or “comprising”, will be understood to imply the inclusion of stated elements but not the exclusion of any other elements.

Hereinafter, various embodiments of the present invention will be described in detail with reference to the accompanying drawings.

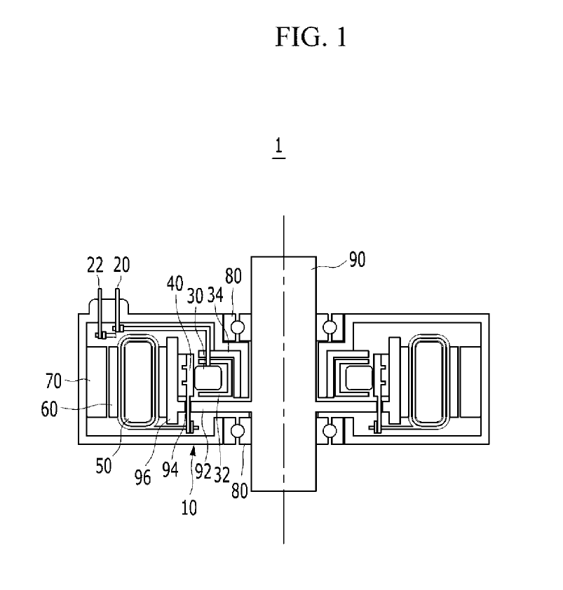

FIG. 1 is a cross-sectional view of an electric motor according to various embodiments of the present invention.

Referring to FIG. 1, an electric motor 1 according to various embodiments of the present invention includes an electric motor case 10 shaped like a cylinder, an electric motor shaft 90 rotatably provided at a center of the electric motor case 10, a magnet 70 provided at an inner circumferential surface of the electric motor case 10, a coil 50 provided to correspond to the magnet 70, a brush 30 provided between the coil 50 and the electric motor shaft 90 and connected to external powers 20 and 22 to transmit current of the external powers 20 and 22, and a commutator 40 for receiving power from the brush 30 to supply the received power to the coil 50.

As illustrated in FIG. 1, in various embodiments of the present invention, the brush 30 is provided between the coil 50 and the electric motor shaft 90, so that it is possible to decrease an entire length of the electric motor 1 without the loss of output power.

A horizontal arm 92 extends from the electric motor shaft 90 in a diameter direction of the electric motor shaft 90, a vertical arm 96 is formed at the horizontal arm 92 in parallel to a longitudinal direction of the electric motor shaft 90, the core 60 is coupled to the vertical arm 96, and the core 60 is wound with the coil 50.

The commutator 40 may be coupled to the vertical arm 96 and be provided between the brush 30 and the vertical arm 96.

As illustrated in FIG. 1, in various embodiments of the present invention, the brush 30 is provided between the coil 50 and the electric motor shaft 90 and the commutator 40 is provided between the brush 30 and the vertical arm 96, thereby decreasing an entire length of the electric motor 1 without the loss of output power.

A bearing 80 is provided between the electric motor case 10 and the electric motor shaft 90, so that it is possible to reduce friction between the electric motor shaft 90 and the electric motor case 10.

The electric motor 1 may further include a brush cover 32 covering the brush 30, and the brush cover 32 may be formed of copper and the like.

The electric motor 1 may further include an insulator 34 provided between the brush cover 32 and the electric motor case 10.

A shaft arm hole 94 is formed at the horizontal arm 92, and the commutator 40 and the coil 50 may be electrically connected to each other through the shaft arm hole 94.

The electric motor 1 may be a DC electric motor or various types of motors, such as an AC electric motor including a universal motor, including a brush and a commutator.

Referring to FIG. 1, an operation of the electric motor according to various embodiments of the present invention will be described.

When current is supplied from the external powers 20 and 22, the current is supplied to the brush 30 provided between the coil 50 and the electric motor shaft 90.

In the drawing, two sets of the external powers 20 and 22 and the brushes 30 are illustrated, but the number of sets is not limited thereto, and three or more sets of the external powers 20 and 22 and the brushes 30 may be included.

The commutator 40 is provided between the brush 30 and the vertical arm 96 and forms a set with the brush 30, and receives current from the brush 30 and supplies the received current to the coil 50.

The coil 50 forms a magnetic field by the supplied current, and rotates by repulsive force against the magnet 70. The coil 50, the core 60 wound with the coil, and the vertical arm 96 connected with the core, the horizontal arm 62, and the shaft 90 rotate by the repulsive force between the coil 50 and the magnet 70, and the commutator 40 connected to the vertical arm 96 repeats the electric connection and short circuit with the brush 30.

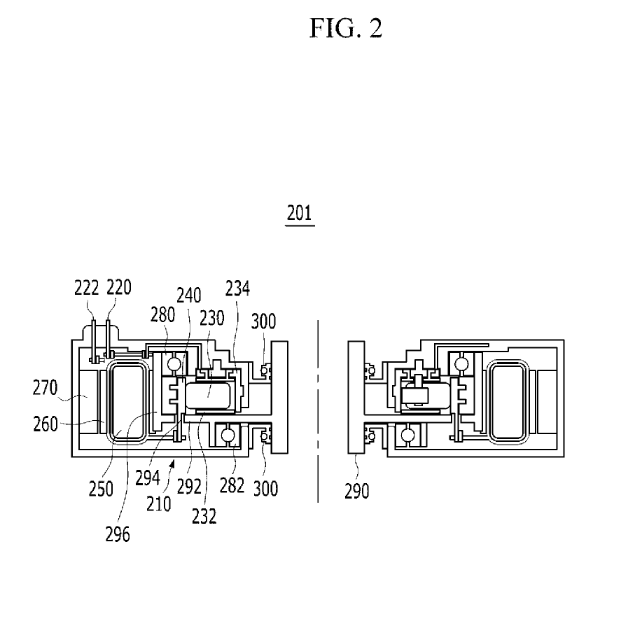

FIG. 2 is a cross-sectional view of an electric motor according to various embodiments of the present invention.

Referring to FIG. 2, an electric motor 201 according to various embodiments of the present invention includes an electric motor case 210 shaped like a cylinder, a hollow electric motor shaft 290 rotatably provided at a center of the electric motor case 210, a magnet 270 provided at an inner circumferential surface of the electric motor case 210, a coil 250 provided to correspond to the magnet 270, a brush 230 provided between the coil 250 and the electric motor shaft 290 and connected to external powers 220 and 222 to transmit current of the external powers 220 and 222, and a commutator 240 for receiving power from the brush 230 to supply the received power to the coil 250.

A horizontal arm 292 extends from the electric motor shaft 290 in a diameter direction of the electric motor shaft 290, a vertical arm 296 is formed at the horizontal arm 292 in parallel to a longitudinal direction of the electric motor shaft 290, the core 260 is coupled to the vertical arm 296, and the core 260 is wound with the coil 250.

The commutator 240 may be coupled to the vertical arm 296 and be provided between the brush 230 and the vertical arm 296.

As illustrated in FIG. 2, in various embodiments of the present invention, the brush 230 is provided between the coil 250 and the electric motor shaft 290 and the commutator 240 is provided between the brush 230 and the vertical arm 296, thereby decreasing an entire length of the electric motor 201 without the loss of output power.

A sealing member 300 may be provided between the electric motor case 210 and the electric motor shaft 290, and the sealing member 300 prevents foreign substances from flowing in a space between the electric motor case 210 and the electric motor shaft 290.

The electric motor 201 may further include a brush cover 232 surrounding the brush 230 and an insulator 234 provided between the brush cover 232 and the electric motor case 210.

A shaft arm hole 294 is formed at the horizontal arm 292, and the commutator 240 and the coil 250 may be electrically connected to each other through the shaft arm hole 294.

Bearings 280 are provided between the electric motor case 210 and the vertical arm 296 and between the electric motor case 210 and the horizontal arm 292, respectively, so that it is possible to reduce friction between the electric motor shaft 290 and the electric motor case 210.

The electric motor 201 may be a DC electric motor or various types of motors, such as an AC electric motor including a universal motor, including a brush and a commutator.

A configuration and an operation of the electric motor 201 according to various embodiments of the present invention illustrated in FIG. 2 are the same as those of the electric motor 1 according to various embodiments of the present invention illustrated in FIG. 1, except for the shaft, the sealing member, and the bearings, so that the repeated description will be omitted.

For convenience in explanation and accurate definition in the appended claims, the terms inner and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

1. An electric motor, comprising:
an electric motor case having a cylindrical shape;
an electric motor shaft rotatably provided at a center of the electric motor case;
a magnet provided at an inner circumferential surface of the electric motor case;
a coil provided to correspond to the magnet;
a brush provided between the coil and the electric motor shaft and connected with an external power to transmit current of the external power; and
a commutator configured to receive power from the brush and supply the received power to the coil.

2. The electric motor of claim 1, wherein:
a horizontal arm extends from the electric motor shaft in a diameter direction of the electric motor shaft,
a vertical arm is formed at the horizontal arm in parallel to a longitudinal direction of the electric motor shaft,
a core is coupled to the vertical arm, and
the core is wound with the coil.

3. The electric motor of claim 2, wherein:
the commutator is coupled with the vertical arm and is provided between the brush and the vertical arm.

4. The electric motor of claim 1, wherein:
a bearing is provided between the electric motor case and the electric motor shaft.

5. The electric motor of claim 1, further comprising:
a brush cover surrounding the brush.

6. The electric motor of claim 5, further comprising:
an insulator provided between the brush cover and the electric motor case.

7. The electric motor of claim 1, wherein:
a shaft arm hole is formed at the horizontal arm, and the commutator and the coil are electrically connected through the shaft arm hole.

8. The electric motor of claim 1, wherein:
the electric motor is a DC electric motor.

9. The electric motor of claim 1, wherein:
the electric motor is an AC electric motor.

10. An electric motor, comprising:
an electric motor case having a cylindrical shape;
a hollow electric motor shaft rotatably provided at a center of the electric motor case;
a magnet provided at an inner circumferential surface of the electric motor case;
a coil provided to correspond to the magnet;
a brush provided between the coil and the electric motor shaft and connected with an external power to transmit current of the external power; and
a commutator configured to receive power from the brush and supply the received power to the coil.

11. The electric motor of claim 10, wherein:
a horizontal arm extends from the electric motor shaft in a diameter direction of the electric motor shaft,
a vertical arm is formed at the horizontal arm in parallel to a longitudinal direction of the electric motor shaft,
a core is coupled to the vertical arm, and
the core is wound with the coil.

12. The electric motor of claim 11, wherein:
the commutator is coupled with the vertical arm and is provided between the brush and the vertical arm.

13. The electric motor of claim 10, wherein:
a sealing member is provided between the electric motor case and the electric motor shaft.

14. The electric motor of claim 10, further comprising:
a brush cover surrounding the brush.

15. The electric motor of claim 14, further comprising:
an insulator provided between the brush cover and the electric motor case.

16. The electric motor of claim 10, wherein:
a shaft arm hole is formed at the horizontal arm, and
the commutator and the coil are electrically connected through the shaft arm hole.

17. The electric motor of claim 11, wherein:
bearings are provided between the electric motor case and the vertical arm and between the electric motor case and the horizontal arm, respectively.

18. The electric motor of claim 10, wherein:
the electric motor is a DC electric motor.

19. The electric motor of claim 10, wherein:
the electric motor is an AC electric motor.
